(19) United States
(12) Patent Application Publication
(10) Pub. No.: US 2003/0145507 A1
(43) Pub. Date: Aug. 7, 2003

(54) Motion enhancer for fishing bait

(76) Inventors: Maumus F. Claverie III, Houston, TX (US); Charles Dalton, Houston, TX (US)

Correspondence Address: John R. Casperson, PO Box 2174, Friendswood, TX, 77549, US

(21) Appl. No.: 10/068,036

(22) Filed: Feb. 5, 2002

(51) Int. Cl. A01K 69/00; A01K 71/00; A01K 73/00

(52) U.S. Cl. 43/4.5

(57) ABSTRACT

Positioning a body having a rounded trailing edge, such as a spherical body, ahead of the lure causes the lure to follow an erratic path.

### BACKGROUND OF THE INVENTION

The invention relates to a motion enhancer for attachment to a fishing line ahead of a natural or artificial bait to cause the bait to follow an erratic path.

Live prey fish exhibit characterizing body features, body movements, and movements through the water. It is impossible to totally replicate a live prey fish using a dead or artificial bait, although a great deal of time and effort has been expended to approach this goal.

Large game fish, such as billfish, are typically pursued by sport fisherman trolling live, dead, or artificial baits behind the boat. Besides not moving in the manner of a live bait, dead baits are often lacking in the coloration of their live counterparts. For example, dolphinfish, a common big game prey fish, have brilliant rainbow color when alive but are dreary gray when dead. An artificial bait to more accurately replicate the coloration of a live prey fish would be very desirable.

The body movement of a dead bait under trolling conditions further does not closely replicate the body movements of a live bait. Preparation of the dead bait, such as by removing or breaking the backbone, can help. Hard-bodied lures often have a life-like wiggle, but generally fail to closely replicate the shape of the prey fish. A large soft-bodied artificial bait which closely replicates the body movements of a live bait under trolling conditions would be very desirable.

Large dead baits generally drag straight through the water when trolled behind a boat, as do many types of artificial lures. In contrast, a live prey fish generally swims in an erratic path. Feeding fish, which are often the prey fish for still larger big game fish, further occasionally break the water. A device to enhance the motion or path taken by a dead or artificial bait under trolling conditions to more closely replicate a live bait would be very desirable.

It is an object of this invention to provide a trolling lure for marlin that imitates a live bait in both appearance and action that can be trolled at over a range of speeds, such as in the range of 1 to 20 knots.

It is a further object of this invention to provide an artificial trolling lure that is between about 7 and about 70 centimeters in length, as dead baits of this size are often employed for game fish with good results.

It is a further object of this invention to provide a soft-bodied artificial trolling lure, especially for large game fish, which closely replicates the shape, coloration and size of common prey fish, as well as their swimming action.

It is yet another object of this invention to provide a trolling lure implement that can be used with the above noted artificial bait, or with dead baits, to cause the bait to follow an erratic, more life-like, path.

### SUMMARY OF THE INVENTION

In one embodiment of the invention, there is provided a fishing implement comprising a hook, a line, a body and a stop device. The fish hook has an eye end and a barb end. The line is attached to the eye end of the fish hook. The body has a vortex-generating trailing surface and is slidably mounted on the line. A stop device is mounted on the line between the body and the fish hook to prevent the body from sliding against the eye end of the fish hook. The body has a generally circular cross-section with a diameter in the range of about 1 cm to about 20 cm and has apparent density in the range of about 1 to about 8 grams/cc.

In another embodiment of the invention, there is provided a fishing lure comprising an artificial bait, a body having a vortex-generating trailing surface, and a tether connecting the body to the bait. The artificial bait is constructed of a rubbery polymer and has a generally fish-like appearance, a head end and a tail end. The body has a vortex-generating trailing surface facing the artificial bait, a generally circular cross-section, and a diameter. The tether connects the body to the head end of the bait and has a length in the range of about 0.1 to about 10 body diameters.

In another embodiment, there is provided an improvement to a fishing method comprising trolling a bait behind a boat, wherein the bait is connected to the boat by a fishing line. The improvement comprises positioning a body having a vortex-generating trailing surface on the fishing line at a position spaced apart from the bait but sufficiently close to the bait so that an erratic motion is imparted to the bait as the bait is trolled through the water.

We have found that a lure can be made to “swim” like a live bait by positioning a vortex-generating object, such as a sphere, in the water column in front of the lure. A sphere that is not spinning sets up random trailing vortices as it travels through a medium which causes it to behave erratically, for example, in the manner of a knuckleball. By positioning the sphere close to the bait, the bait can be made to appear to dart and wobble, closely approximating the swimming pattern of a live bait. The technique is well suited for trolling for big game fish, such as marlin or tuna, as it is effective to enhance the action of very large baits, as well as being effective for smaller game fish such as sailfish, dolphinfish, wahoo, and king mackerel, as it can also be employed with smaller baits.

### BRIEF DESCRIPTION OF THE DRAWINGS

FIG. 1 is a pictorial representation of one embodiment of the invention.

FIG. 2 is a side sectional view of the invention as shown in FIG. 1.

FIG. 3 is a cross-sectional view of a portion of the invention shown in FIG. 1.

FIG. 4 is a cross-sectional view of another portion of the invention shown in FIG. 1.

FIG. 5 is a pictorial representation of another embodiment of the invention.

FIG. 6 is a side sectional view of the invention as shown in FIG. 5.

FIG. 7 is a pictorial representation of the invention as shown in FIG. 5 illustrating certain aspects of its use.

### DETAILED DESCRIPTION OF THE INVENTION

In one embodiment of the invention, there is provided a fishing implement 4 comprising a hook 6, a line 8, a body 10 and a stop device 12, which can be in the form of an assembly, for example, of beads. The fish hook has an eye end 14 and a barb end 16. The line is attached to the eye end of the fish hook. The body has a vortex-generating trailing surface 18 and is slidably mounted on the line. The stop device is mounted on the line between the body and the fish hook to prevent the body from sliding against the eye end of the fish hook. The body 10 has a generally circular cross-section with a diameter in the range of about 1 cm to about 20 cm and has apparent density in the range of about 1 to about 8 grams/cc.

Preferably, the body has apparent density in the range of about 1 to about 5 grams/cc and more preferably in the range of 1 to 3 grams/cc. It can be provided with a solid construction of polymer, aluminum or glass, for example and have an apparent density within this range, or it can be formed of a hollow shell formed from these or other materials which is permitted to fill with water. Most preferably, the body has an apparent density in the range of about 1 to about 2 grams/cc and is constructed of a rubbery polymer such as a silicone or urethane rubber. Most preferably, the body is transparent or translucent, to best avoid spooking the fish.

The body is also preferably generally spherical and for large marlin-sized baits preferably has a diameter in the range of about 2 to about 10 cm, as a body of this size will be effective at enhancing the action of large trolling lures. For smaller game fish, a smaller bait is suitable, and a smaller body having a diameter in the range of about 1 to about 5 cm is expected to provide good lure action with minimal drag.

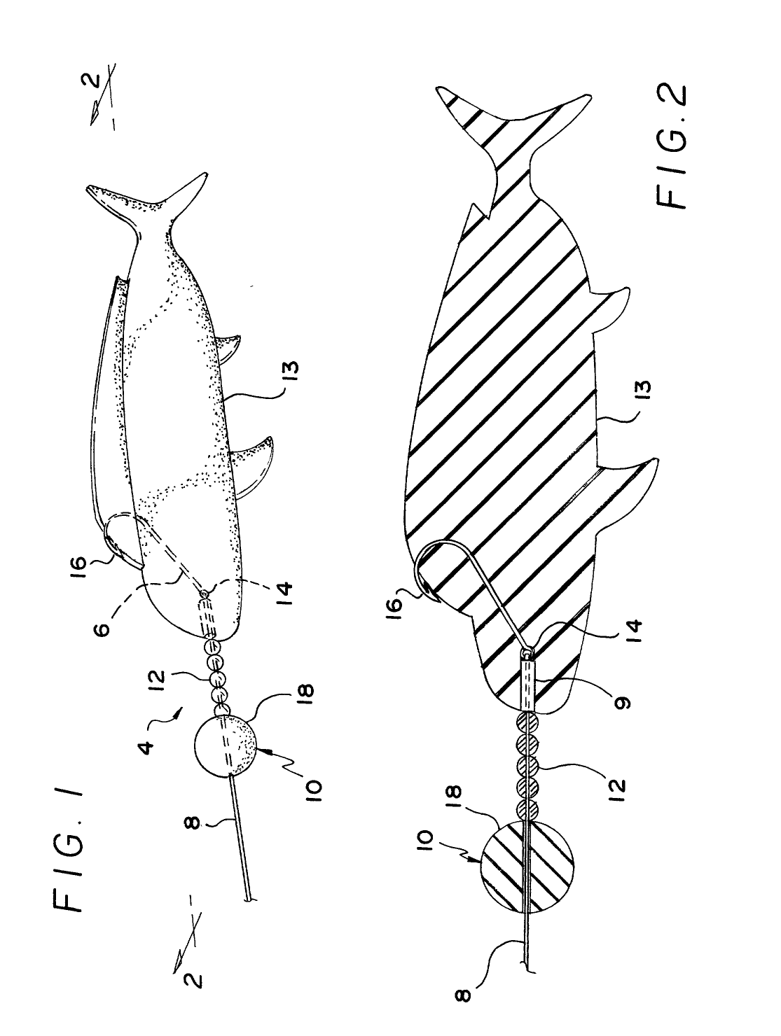

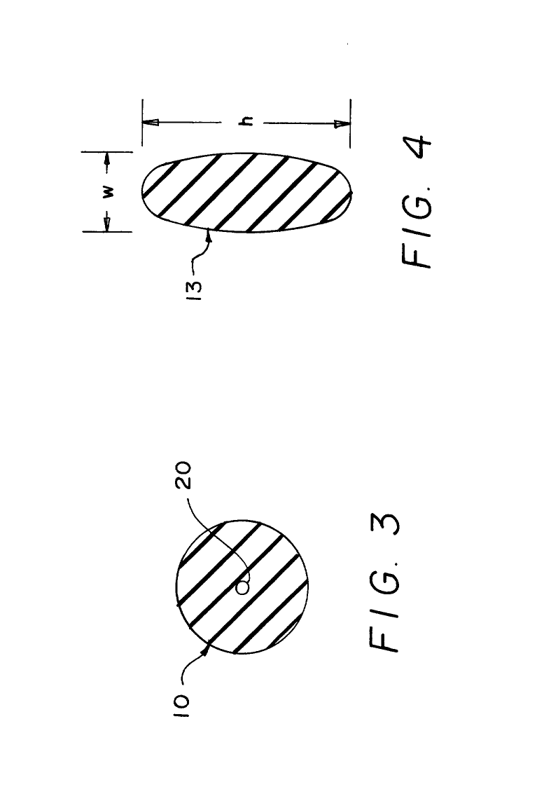

In the embodiment of the invention shown in FIGS. 1 and 2, the body has a borehole 20 extending through its diameter (see FIG. 3) and the line passes through the borehole. The bait 13 is preferably provided with a generally longitudinally extending hard tubular insert 9 positioned in the head end of the bait which provides a load-bearing surface to mount the bait to the hook.

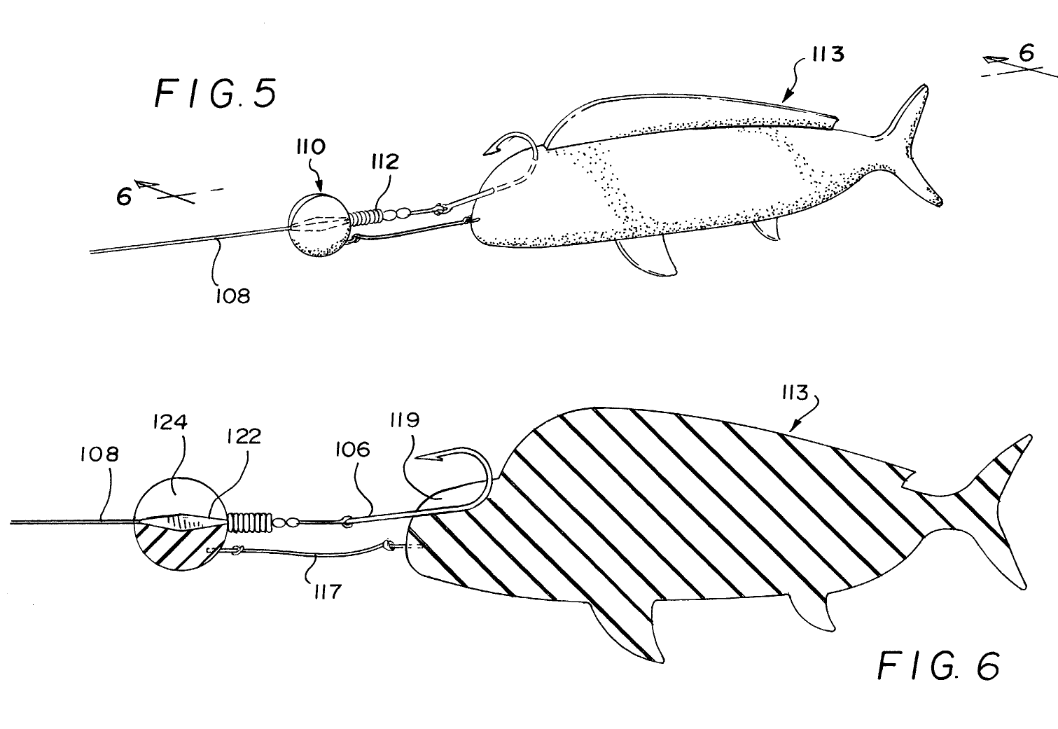

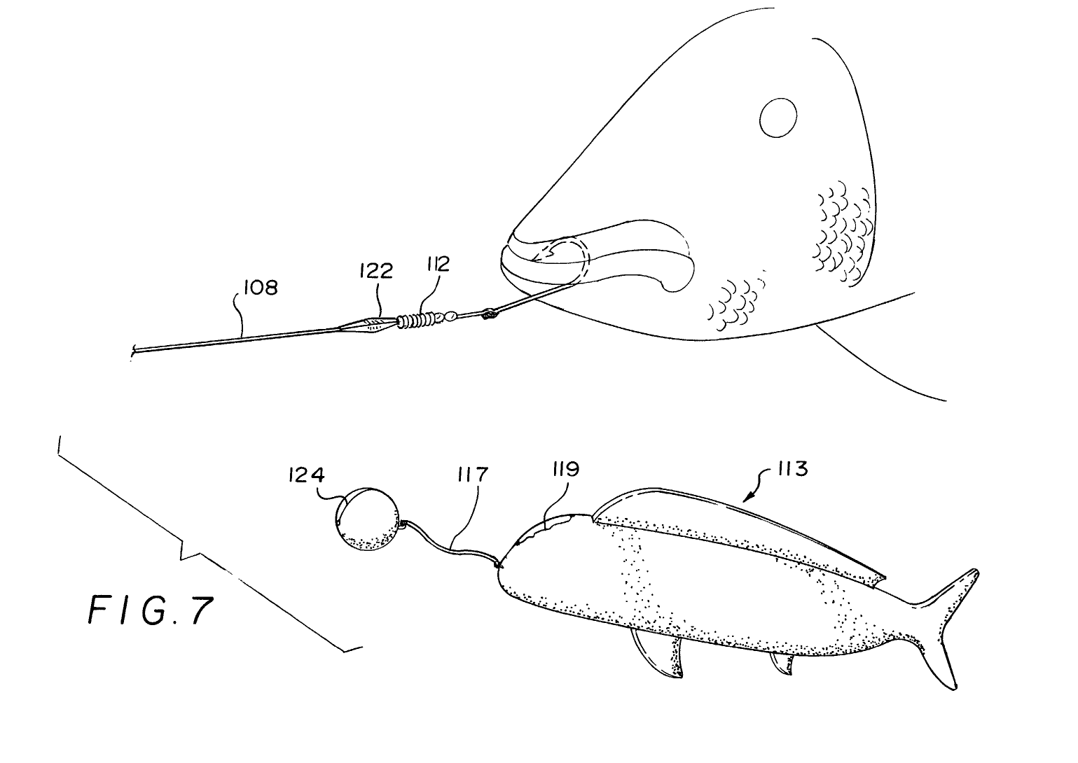

In the embodiment of the invention shown in FIGS. 5 and 6, a pin 122 is positioned on the line 108 against the stop device 112. The body 110 is slidably mounted over the pin and is prevented by the pin from sliding against the hook. The pin can have a lure-like shape if desired, for example, it can be provided with the form of a metal jig or spoon. Preferably, the spherical body has a slot 124 transversely opening into the diametrical borehole and having a width which is wide enough to pass the line but not so wide as to pass the pin, so that the spherical body can be transversely passed onto the line and longitudinally slid onto the pin. An artificial bait 113 constructed of a rubbery polymer and having a generally fish-like appearance, a head end and a tail end, is connected to the spherical body by a tether line 117. The hook 106 is carried by the head end of the bait. Hook up of a large fish causes the bait to be dislodged from the hook and the spherical body to slide up the line to become dislodged from the pin. See FIG. 7. To facilitate hook up, the bait can be provided with a longitudinally extending slot 1 19 in its forehead and the hook is positioned in the longitudinally extending slot.

It is expected that a bait having a fish-like appearance and a length in the range of about 7 to about 70 cm. will provide good results. Such baits can be constructed of a rubbery polymer and rigged so that the line extends generally longitudinally from the bait and the hook is positioned so that the barb end of the hook protrudes above an upper portion of the head end of the bait. For game fish having an expected weight in the range of about 4 to about 40 kg., a bait having a length in the range of about 7 cm to about 35 cm is expected to provide good results. For game fish having an expected weight in the range of about 40 kg to about 400 kg and beyond, a bait having a length in the range of about 20 cm to about 70 cm is expected to be more useful. These baits can be molded to resemble dolphinfish, tuna, mackerel or jackfish, for example.

The stop device 12, 112 is mounted on the line between the ball and the fish hook to space the spherical body in the range of about 0.1 to about 10 diameters from the eye end of the fish hook, preferably in the range of about 0.2 to about 5 diameters from the eye end of the fish hook. Beads are highly effective stop devices. The line upon which the beads are mounted can be of any desired construction, but marlin leader, which is a nylon monofilament having a breaking strength of the a hundred pounds, such as 400 pounds, is preferred. The beads are preferably slidably mounted on the leader.

It is believed that best results will be obtained when the spherical body presents a cross-sectional area in a plane transverse to the line which is in the range of about 25% to about 500% of the cross-sectional area of the bait, preferably in the range of about 50% to about 250% of the cross-sectional area of the bait. These cross-sections are illustrated in FIGS. 3 and 4 and do not include the fins. Preferably, the diameter of the spherical body is no greater than about the height of the bait, see “h” in FIG. 4, and more preferably is in the range of from about 50% to 80% of the height of the bait.

For side to side darting action, it is expected that a relatively tall, thin bait (as viewed in the cross-section of FIG. 4), will have greater lateral action than a more cylindrical bait. Providing the bait with a height and a width and a height:width ratio which is in the range of 1.5:1 to 5:1 is expected to give good results.

In another embodiment of the invention, there is provided a fishing lure comprising an artificial bait, a body having a vortex-generating trailing surface, and a tether connecting the body to the bait. See the loose bait assembly in FIG. 7. The artificial bait is constructed of a rubbery polymer and has a generally fish-like appearance, a head end and a tail end. The body has a vortex-generating trailing surface facing the artificial bait, a generally circular cross-section, and a diameter. The tether connects the body to the head end of the bait and has a length in the range of about 0.1 to about 10 body diameters.

The lure can be as described previously, and in one embodiment can have a fish-like appearance selected from the group consisting of a dolphinfish, a tuna, a mackerel and a jackfish, and a length in the range of about 7 cm to about 70 cm.

The body can be as described previously, with a diameter in the range of about 1 to 20 centimeters, preferably about 2 to about 10 centimeters, and an apparent density in the range of about 1 to about 8 grams/cc, preferably about 1 to about 3 grams/cc.

The method of the invention can be viewed as an improvement to known fishing methods, in that a body having a vortex-generating surface is positioned on the line close enough to the bait to cause the bait to follow an erratic path through the water, preferably by trolling. The specifics of the body, the bait, and their spacing and relative dimensions can be as previously described. The combination can be trolled at big game speeds, such as in the range of about 1 to about 20 knots, usually in the range of about 2 to about 12 knots. Due to the drag caused by the body, the use of heavy tackle, such as 50 pound class and heavier, is preferred.

While certain preferred embodiments of the invention have been described herein, the invention is not to be construed as being so limited, except to the extent that such limitations are found in the claims.

1. Apparatus comprising
a fish hook having an eye end and a barb end;
a line attached to the eye end of the fish hook;
a body having a vortex-generating trailing surface slidably mounted on the line; and
a stop device mounted on the line between the body and the fish hook to prevent the body from sliding against the eye end of the fish hook;
wherein the body has a generally circular cross-section with a diameter in the range of about 1 cm to about 20 cm and has apparent density in the range of about 1 to about 8 grams/cc.

2. Apparatus as in claim 1 wherein the apparent density is in the range of about 1 to about 5 grams/cc.

3. Apparatus as in claim 2 wherein the apparent density is in the range of about 1 to about 3 grams/cc.

4. Apparatus as in claim 3 wherein the body is constructed of a rubbery polymer.

5. Apparatus as in claim 4 wherein the rubbery polymer is translucent.

6. Apparatus as in claim 3 wherein the body is generally spherical and has a diameter in the range of about 2 to about 10 cm.

7. Apparatus as in claim 6 wherein the body has a borehole extending through its diameter and the line passes through the borehole.

8. Apparatus as in claim 7 further comprising a pin positioned on the line against the stop device, wherein the body is slidably mounted over the pin and is prevented by the pin from sliding against the hook.

9. Apparatus as in claim 8 wherein the spherical body has a slot transversely opening into the diametrical borehole and having a width which is wide enough to pass the line but not so wide as to pass the pin, so that the spherical body can be transversely passed onto the line and longitudinally slid onto the pin.

10. Apparatus as in claim 9 further comprising an artificial bait constructed of a rubbery polymer and having a generally fish-like appearance, a head end and a tail end, and a tether line connecting the spherical body with the head end of the bait.

11. Apparatus as in claim 10 wherein the bait has a fish-like appearance and a length in the range of about 7 to about 70 cm.

12. Apparatus as in claim 11 wherein the bait has a forehead and a longitudinally extending slot in its forehead, wherein the hook is positioned in the longitudinally extending slot.

13. Apparatus as in claim 6 further comprising an artificial bait constructed of a rubbery polymer and having a generally fish-like appearance, a head end and a tail end, wherein the hook is positioned in said artificial bait so that the line extends generally longitudinally from the head end of the bait and the barb end of the hook protrudes above an upper portion of the head end of the bait.

14. Apparatus as in claim 13 wherein the bait has a fish-like appearance and a length in the range of about 7 cm to about 70 cm.

15. Apparatus as in claim 14 wherein the bait has a generally longitudinally extending hard tubular insert positioned in the head end of the bait and providing a load bearing surface to mount the bait to the hook.

16. Apparatus as in claim 13 wherein the stop device is mounted on the line between the ball and the fish hook to space the spherical body in the range of about 0.1 to about 10 diameters from the eye end of the fish hook.

17. Apparatus as in claim 13 wherein the stop device is mounted on the line between the spherical body and the fish hook to space the spherical body in the range of about 0.2 to about 5 diameters from the eye end of the fish hook.

18. Apparatus as in claim 13 wherein the stop device comprises a plurality of beads slidably mounted on the line.

19. Apparatus as in claim 13 wherein the spherical body presents a cross-sectional area in a plane transverse to the line which is in the range of about 25% to about 500% of a cross-sectional area of the bait in a plane transverse to the line.

20. Apparatus as in claim 19 wherein the spherical body presents a cross-sectional area in a plane transverse to the line which is in the range of about 50% to about 250% of the cross-sectional area of the bait in a plane transverse to the line.

21. Apparatus as in claim 20 wherein the bait has a height and a width and a height:width ratio which is in the range of 1.5:1 to 5:1.

22. A fishing lure comprising
an artificial bait constructed of a rubbery polymer and having a generally fish-like appearance, a head end and a tail end,
a body having a vortex-generating trailing surface facing the artificial bait, said body having a generally circular cross-section and a diameter, and
a tether connecting the body to the head end of the bait, said tether having a length in the range of about 0.1 to about 10 body diameters.

23. A fishing lure as in claim 22 wherein the bait has a fish-like appearance and a length in the range of about 7 cm to about 70 cm.

24. A fishing lure as in claim 23 wherein the body has a diameter in the range of about 1 to about 20 centimeters.

25. A fishing lure as in claim 24 wherein the body has a diameter in the range of about 2 to about 10 centimeters.

26. A fishing lure as in claim 22 wherein the body has an apparent density in the range of about 1 to about 8 grams/cc.

27. A fishing lure as in claim 26 wherein the body as an apparent density in the range of about 1 to about 5 grams/cc.

28. In a method of fishing comprising
trolling a bait behind a boat, said bait being connected to the boat by a fishing line,
the improvement comprising
positioning a body having a vortex-generating trailing surface on the fishing line at a position spaced apart from the bait but sufficiently close to the bait so that the bait is caused to follow an erratic path.

29. A method as in claim 28 wherein the body is generally spherical and has an apparent density in the range of about 1 to about 3 grams/cc.

30. A method as in claim 29 wherein the body has a diameter in the range of about 2 to about 10 centimeters.

31. A method as in claim 30 wherein the body is positioned at a distance in the range of about 0.2 to about 5 body diameters from the bait.
